(19) United States
(12) Patent Application Publication
(10) Pub. No.: US 2017/0147021 A1
(43) Pub. Date: May 25, 2017

(54) Internet-of-things System Having Single-mode or Multi-mode Energy Harvesting Function

(71) Applicant: Top Victory Investments Ltd., Kowloon (HK)

(72) Inventor: Tim Wu, New Taipei City (TW)

(21) Appl. No.: 14/945,503

(22) Filed: Nov. 19, 2015

(51) Int. Cl. G05F 1/66; G05B 15/02

(52) U.S. Cl. CPC G05F 1/66; G05B 15/02

(57) ABSTRACT

An Internet-of-Things (IoT) system includes energy harvesting devices, IoT devices, and a monitoring device. The energy harvesting devices harvest the same or different types of ambient energy to provide a single-mode or multi-mode energy harvesting function, respectively. Each IoT device coupled to at least one energy harvesting device includes a control module, a wireless network module, and an energy storage module. The control module determines, according to energy supplied by the at least one energy harvesting device, whether to control the at least one energy harvesting device to supply energy to the IoT device and charge the energy storage module, or whether to control the energy storage module to supply energy to the IoT device. The wireless network modules of the IoT devices are coupled together to form a wireless ad hoc network (WANET). The monitoring device monitors operating conditions of the IoT devices through the WANET.

### BACKGROUND OF THE INVENTION

1. Field of the Invention

The present invention relates to the field of Internet of Things (IoT) and, more particularly, to an IoT system including IoT devices and having a single-mode or multi-mode energy harvesting function.

2. Description of the Prior Art

With the development of the IoT technology, its applications are gradually expanded into the industrial, commercial, medical, consumption, and military fields. Power source is always critical to prolonging the service life and reducing the cost of an IoT system including IoT devices. In environmental extremes or other occasions unreachable to human beings, or when an IoT device moves or changes, it is difficult or even impossible to replace a battery, making it crucial to effectively supply energy to the IoT device. An effective solution is energy harvesting technology which captures ambient energy such as solar energy and converts the captured ambient energy into electrical energy to supply energy to the IoT device.

### SUMMARY OF THE INVENTION

The present invention is adapted to providing an IoT system including IoT devices and having a single-mode or multi-mode energy harvesting function.

According to an aspect of the present invention, there is provided an IoT system having a single-mode or multi-mode energy harvesting function. The IoT system includes a plurality of energy harvesting devices, a plurality of IoT devices, and a monitoring device. The plurality of energy harvesting devices harvest ambient energy. The plurality of energy harvesting devices harvest the same type of ambient energy to provide the single-mode energy harvesting function, or different types of ambient energy to provide the multi-mode energy harvesting function. Each of the plurality of IoT devices includes a control module, a wireless network module, and an energy storage module, and the control module is coupled to the wireless network module, the energy storage module, and at least one of the plurality of energy harvesting devices. The control module determines whether energy supplied by the at least one of the plurality of energy harvesting devices is more than a first threshold, and, if yes, controls the at least one of the plurality of energy harvesting devices to supply energy to corresponding one of the plurality of IoT devices and charge the energy storage module, or, if no, controls the energy storage module to supply energy to the corresponding one of the plurality of IoT devices. The wireless network modules of the plurality of IoT devices are coupled together to form a wireless ad hoc network (WANET). The monitoring device monitors operating conditions of the plurality of IoT devices through the WANET.

According to another aspect of the present invention, when the at least one of the plurality of energy harvesting devices supplies energy to the corresponding one of the plurality of IoT devices and charges the energy storage module, the control module further determines whether energy stored in the energy storage module is more than a second threshold, and, if yes, controls the at least one of the plurality of energy harvesting devices to stop supplying energy to the corresponding one of the plurality of IoT devices and charging the energy storage module, and further determines whether to control energy harvested by the at least one of the plurality of energy harvesting devices to transfer to another one of the plurality of IoT devices according to the monitoring device.

According to another aspect of the present invention, when the energy storage module supplies energy to the corresponding one of the plurality of IoT devices, the control module further determines whether energy stored in the energy storage module is less than a third threshold, and, if yes, controls the wireless network module to notify the monitoring device through the WANET to search external energy to support.

According to another aspect of the present invention, the monitoring device sends a roll-call signal to the plurality of IoT devices per a specific time period through the WANET, and receives response signals transmitted from the plurality of IoT devices to determine the operating conditions of the plurality of IoT devices.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of an IoT system including IoT devices according to an embodiment of the present invention; and

FIG. 2 is a flowchart of a control method of a control module of an IoT device according to an embodiment of the present invention.

### DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

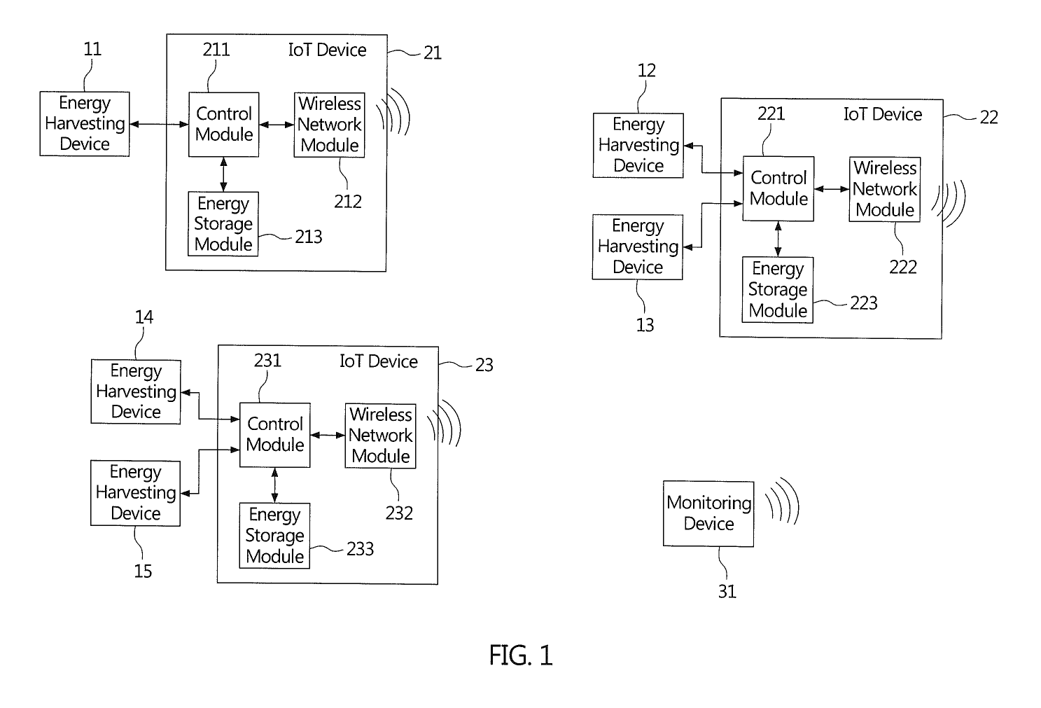

FIG. 1 is a block diagram of an IoT system including IoT devices according to an embodiment of the present invention. Referring to FIG. 1, an IoT system includes energy harvesting devices 11 to 15, IoT devices 21 to 23, and a monitoring device 31. The energy harvesting devices 11 to 15 are used to harvest ambient energy, meaning capturing ambient energy and converting the captured ambient energy into electrical energy. The energy harvesting device may be a solar cell for harvesting ambient energy of light, a solar thermal collector for harvesting ambient energy of heat, a thermoelectric generator for harvesting ambient energy of a temperature difference, a piezoelectric transducer for harvesting ambient energy of vibration, or a rectenna for harvesting ambient energy of an electromagnetic wave.

In an embodiment, the energy harvesting devices 11 to 15 may be of the same type to harvest the same type of ambient energy, and therefore the IoT system may provide a single-mode energy harvesting function. In another embodiment, the energy harvesting devices 11 to 15 may be of different types to harvest at least two different types of ambient energy, and therefore the IoT system may provide a multi-mode energy harvesting function.

Each of the IoT devices 21 to 23, for example the IoT device 2i, includes a control module 2i1, a wireless network module 2i2, and an energy storage module 2i3, where i is an integer ranging from 1 to 3. The control module 2i1 is coupled to the wireless network module 2i2, the energy storage module 2i3, and at least one of the energy harvesting devices 11 to 15. In the embodiment, the control module 211 of the IoT device 21 is coupled to the energy harvesting device 11, the control module 221 of the IoT device 22 is coupled to the energy harvesting devices 12 and 13, and the control module 231 of the IoT device 23 is coupled to the energy harvesting devices 14 and 15.

The wireless network modules 212, 222, and 232 of the IoT devices 21 to 23 are coupled together to form a wireless ad hoc network (WANET) (not shown). The monitoring device 31 monitors operating conditions of the IoT devices 21 to 23 through the WANET. Specifically speaking, the monitoring device 31 also includes a wireless network module (not shown) for joining the WANET.

In an embodiment, the IoT devices 21 to 23 may include a detector, a sensor, an alarm, and/or an information display, and the energy storage module may include a rechargeable battery, a capacitor, and/or a supercapacitor.

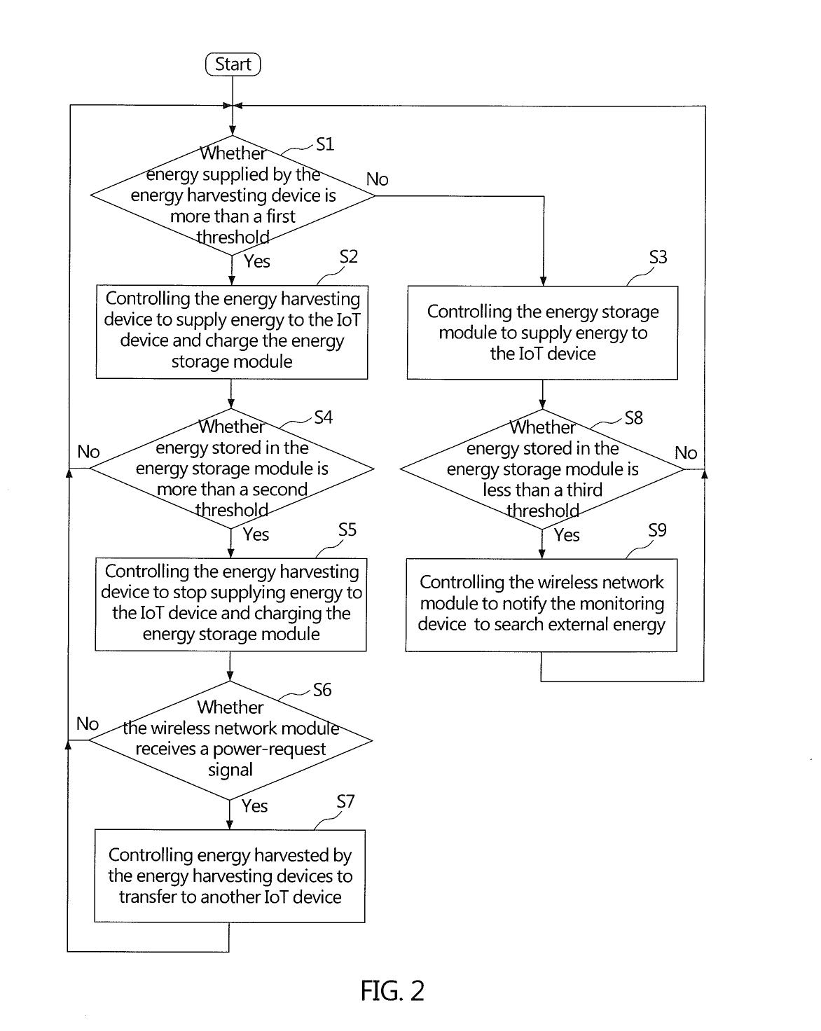

FIG. 2 is a flowchart of a control method of a control module of an IoT device according to an embodiment of the present invention. Referring to FIG. 1 and FIG. 2, the IoT device 21 is taken as an example. At step S1, the control module 211 determines whether energy supplied by the energy harvesting device 11 is more than a first threshold. At step S2, if the energy supplied by the energy harvesting device 11 is more than the first threshold, it represents that the energy harvesting device 11 may harvest ambient energy to generate enough electrical energy, and therefore the control module 211 controls the energy harvesting device 11 to supply electrical energy to the IoT device 21 and charge the energy storage module 213. At step S3, if the energy supplied by the energy harvesting device 11 is less than the first threshold, it represents that the energy harvesting device 11 may not generate enough electrical energy, and therefore the control module 211 controls the energy storage module 213, rather than the energy harvesting device 11, to supply electrical energy to the IoT device 21.

At step S4, when the energy harvesting device 11 supplies energy to the IoT device 21 and charges the energy storage module 213, the control module 211 further determines whether energy stored in the energy storage module 213 is more than a second threshold. If the energy stored in the energy storage module 213 is more than the second threshold, it represents that the energy storage module 213 has stored enough electrical energy and does not need to be charged anymore, and therefore, at step S5, the control module 211 controls the energy harvesting device 11 to stop supplying energy to the IoT device 21 and charging the energy storage module 213. Moreover, the control module 211 further controls the wireless network module 212 to sends a power-good signal to the monitoring device 31 through the WANET.

At step S6, the control module 211 further determines whether the wireless network module 212 receives a power-request signal from the monitoring device 31 through the WANET. If the wireless network module 212 receives a power-request signal, it represents that the monitoring device 31 notifies the IoT device 21 that another IoT device, for example the IoT device 23 nearest to the IoT device 21, will lack energy because energy stored in the energy storage module 233 is less than a third threshold and will be not enough to supply energy to the IoT device 23 while the energy harvesting devices 14 and 15 has not generated enough energy to supply energy to the IoT device 23, and therefore, at step S7, the control module 211 controls energy harvested by the energy harvesting device 11 to transfer to the IoT device 23 in response to the power-request signal from the monitoring device 31.

Referring again to step S4, if the control module 211 determines that energy stored in the energy storage module 213 is less than the second threshold, it represents that the energy storage module 213 has not stored enough electrical energy yet and needs to keep on charging, and therefore returns to step S1. Referring again to step S6, if the control module 211 determines that the wireless network module 212 does not receive a power-request signal from the monitoring device 31 through the WANET, it represents that no IoT device near to the IoT device 21 searches external energy to support, and therefore returns to step S1.

Referring again to step S3, because the energy supplied by the energy harvesting device 11 is less than the first threshold, the control module 211 controls the energy storage module 213, rather than the energy harvesting device 11, to supply electrical energy to the IoT device 21. Moreover, at step S8, the control module 211 further determines whether energy stored in the energy storage module 213 is less than the third threshold. At step S9, if energy stored in the energy storage module 213 is less than the third threshold, it represents that energy stored in the energy storage module 213 will be not enough to supply energy to the IoT device 21 while the energy harvesting device 11 has not generated enough energy to supply energy to the IoT device 21, resulting that the IoT device 21 will lack energy, and therefore the control module 211 controls the wireless network module 212 to send a power-request signal to the monitoring device 31 through the WANET to notify the monitoring device 31 that the IoT device 21 needs to search external energy to support. Then, it returns to step S1.

Referring again to FIG. 1, in the embodiment, the monitoring device 31 may send a roll-call signal to the IoT devices 21 to 23 per a specific time period through the WANET, and receives response signals transmitted from the IoT devices 21 to 23 to determine the operating conditions of the IoT devices 21 to 23. The operating conditions include, for example, energy storage conditions of the energy storage modules 213, 223, and 233, energy supply conditions of the energy harvesting devices 11 to 15, network connection conditions of the WANET. In an embodiment, the aforementioned specific time period may be 12 hours, 24 hours, or 30 minutes.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. An Internet-of-Things (IoT) system having a single-mode or multi-mode energy harvesting function, the IoT system comprising:
a plurality of energy harvesting devices for harvesting ambient energy, wherein the plurality of energy harvesting devices harvest the same type of ambient energy to provide the single-mode energy harvesting function, or different types of ambient energy to provide the multi-mode energy harvesting function;
a plurality of IoT devices, wherein each of the plurality of IoT devices comprises a control module, a wireless network module, and an energy storage module, and the control module is coupled to the wireless network module, the energy storage module, and at least one of the plurality of energy harvesting devices, wherein the control module determines whether energy supplied by the at least one of the plurality of energy harvesting devices is more than a first threshold, and, if yes, controls the at least one of the plurality of energy harvesting devices to supply energy to corresponding one of the plurality of IoT devices and charge the energy storage module, or, if no, controls the energy storage module to supply energy to the corresponding one of the plurality of IoT devices, wherein the wireless network modules of the plurality of IoT devices are coupled together to form a wireless ad hoc network (WANET); and
a monitoring device for monitoring operating conditions of the plurality of IoT devices through the WANET.

2. The IoT system of claim 1, wherein, when the at least one of the plurality of energy harvesting devices supplies energy to the corresponding one of the plurality of IoT devices and charges the energy storage module, the control module further determines whether energy stored in the energy storage module is more than a second threshold, and, if yes, controls the at least one of the plurality of energy harvesting devices to stop supplying energy to the corresponding one of the plurality of IoT devices and charging the energy storage module, and further determines whether to control energy harvested by the at least one of the plurality of energy harvesting devices to transfer to another one of the plurality of IoT devices according to the monitoring device.

3. The IoT system of claim 1, wherein, when the energy storage module supplies energy to the corresponding one of the plurality of IoT devices, the control module further determines whether energy stored in the energy storage module is less than a third threshold, and, if yes, controls the wireless network module to notify the monitoring device through the WANET to search external energy to support.

4. The IoT system of claim 1, wherein the monitoring device sends a roll-call signal to the plurality of IoT devices per a specific time period through the WANET, and receives response signals transmitted from the plurality of IoT devices to determine the operating conditions of the plurality of IoT devices.

5. The IoT system of claim 4, wherein the specific time period comprises 12 hours, 24 hours, or a time period more than 0 and less than 60 minutes.

6. The IoT system of claim 1, wherein the plurality of energy harvesting devices comprise a solar cell for harvesting ambient energy of light.

7. The IoT system of claim 1, wherein the plurality of energy harvesting devices comprise a solar thermal collector for harvesting ambient energy of heat.

8. The IoT system of claim 1, wherein the plurality of energy harvesting devices comprise a thermoelectric generator for harvesting ambient energy of a temperature difference.

9. The IoT system of claim 1, wherein the plurality of energy harvesting devices comprise a piezoelectric transducer for harvesting ambient energy of vibration.

10. The IoT system of claim 1, wherein the plurality of energy harvesting devices comprise a rectenna for harvesting ambient energy of an electromagnetic wave.

11. The IoT system of claim 1, wherein the plurality of IoT devices comprise a detector, a sensor, an alarm, or an information display.

12. The IoT system of claim 1, wherein the energy storage module comprises a rechargeable battery, a capacitor, or a supercapacitor.
